(19) United States
(12) Patent Application Publication
(10) Pub. No.: US 2008/0139354 A1
(43) Pub. Date: Jun. 12, 2008

(54) Traction Mechanism Drive, Especially Belt Drive For Secondary Units of a Combustion Engine

(75) Inventor: Michael Bogner, Eckental (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/911,366

(22) PCT Filed: Feb. 1, 2006
(86) PCT No.: PCT/EP06/00838

§ 371 Date: Oct. 12, 2007

(30) Foreign Application Priority Data
Apr. 13, 2005 (DE) 10 2005 017 038.2

(51) Int. Cl. F16H 7/12

(52) U.S. Cl. 474/134; 474/135

(57) ABSTRACT

A belt drive including a pulley (2) of a crankshaft (KW), a pulley (4) of the starter generator (SG), a first tensioning system (6) having a tension lever arm (7) and a tension roller (8), and a second tensioning system (9) including a tension lever arm (10) and a tension roller (11). The first tension roller (8) is allocated to a starter related loose run (13′) while the second tension roller (11) is assigned to a drive-related loose run (14). The change in position of the second tension roller (11) is limited during a starting operation by disposing the second tensioning system (9) in such a way that the second tension roller (11) in the starter related traction run branches (14a′, 14b′) only to the point where the second tension lever arm (10) is located in a type if dead center position nearly parallel to a resulting force of the two starter related traction run branches (14a′, 14b′).

### FIELD OF THE INVENTION

The invention relates to a traction mechanism drive for secondary units of a combustion engine, especially according to the preamble of claim 1.

### BACKGROUND OF THE INVENTION

In the Japanese laid-open application 2001 059 555 A, a traction mechanism drive, especially a belt drive for secondary units of a combustion engine, is disclosed, with a pulley of the crankshaft and with a pulley of a starter generator, and also with a first tensioning system, which has a first tension lever arm and a first tension roller, as well as with a second tensioning system, which has a second tension lever arm and a second tension roller, wherein the first tension roller is in pressure contact with the belt directly after the pulley of the starter generator with a starter-related loose run over a small belt contact and the second tension roller is in pressure contact with the belt directly after the pulley of the crankshaft with a drive-related loose run over a belt contact of ca. 180°, and the drive-related loose run operates as a tensioned run in the starting mode and that a change in position of the second tension roller caused by this change to a tensioned run is limited. The way this limitation is realized does not emerge from the publication above.

### OBJECT OF THE INVENTION

The invention is based on the objective of creating a belt drive according to the preamble of claim 1, which has means for limiting the change in position of the second tension roller in the starting mode.

### SUMMARY OF THE INVENTION

The objective is met by the features of the independent claim 1.

Through skillful arrangement of the second tensioning system, it is achieved that the second tension roller in the starter-related tensioned run is moved out of the belt drive due to the resulting force of the two starter-related tensioned run branches only until the second tension lever arm is located in a type of “dead-center position” nearly parallel to the resulting force of the two starter-related tensioned run branches. Therefore, the active part of the second tension lever arm goes to zero, so that the second tension roller is located in a nearly fixed position.

Because the second tensioning system experiences a high load in this “dead-center position” of the second tension lever arm, it is advantageous that the second tensioning system is produced at least partially using a high-strength aluminum squeeze casting or rheocasting method or from steel investment casting.

For simplifying the assembly of the traction mechanism drive, it is advantageous that at least one of the two tensioning systems is pre-tensioned and cottered for assembly and that at least the non-cottered tensioning system has a corresponding tool holder, which is used for tensioning this system out of the belt drive.

For the service life of the belt, it is important that the two tensioning systems have a separate design for the starter and the generator mode. Therefore, the greatest part of the operating time of the traction mechanism drive can be navigated with the smaller and therefore gentler pre-tensioning sufficient for the generator mode, while the increased pre-tensioning of the starter mode is necessary only temporarily.

### BRIEF DESCRIPTION OF THE DRAWINGS

Additional features of the invention emerge from the following description and the drawings, in which an embodiment of the invention is shown schematically.

Shown are:

FIG. 1 a view of the belt drive according to the invention in the generator mode;

FIG. 2 a view according to FIG. 1 but in the starting mode.

### DETAILED DESCRIPTION OF THE DRAWINGS

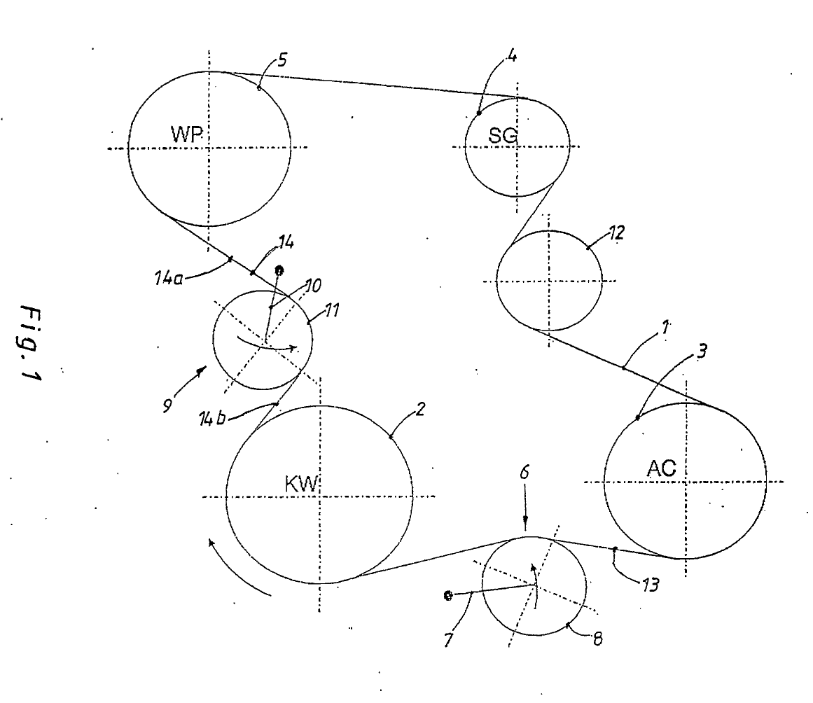

FIG. 1 shows a view of a belt drive, which is used for driving secondary units of a not-shown combustion engine.

The belt drive has a belt 1 which connects the pulleys of the secondary units and the pulley 2 of the crankshaft KW for transmitting tensile and thus torque forces.

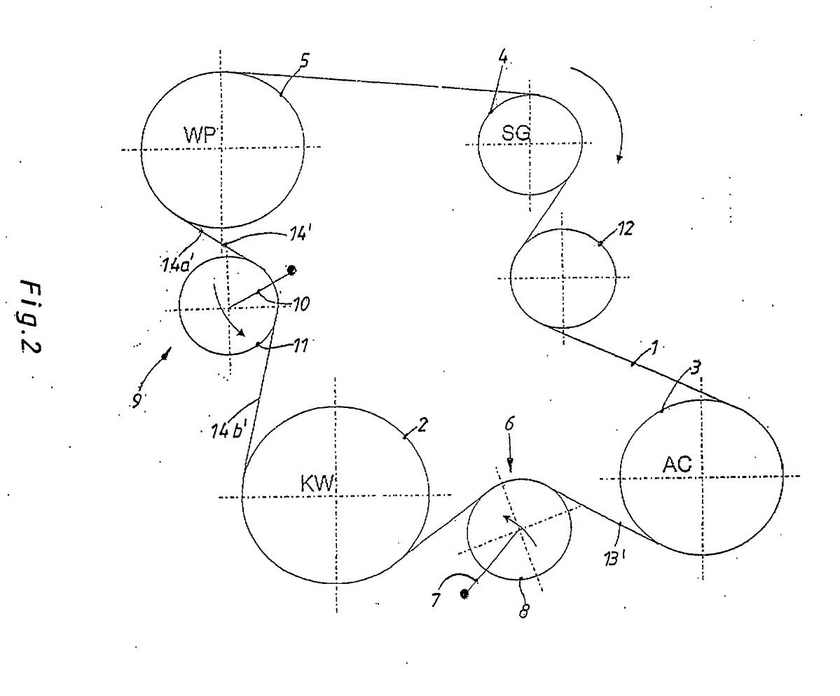

As shown in FIGS. 1 and 2, in the generator mode, the pulley 2 of the crankshaft drives the following pulleys:

### Pulley 3 of an air conditioning system compressor AC,

### Pulley 4 of a starter generator SG, and

### Pulley 5 of a water pump WP.

In addition, a first tensioning system 6 is arranged in the belt drive with a first tension lever arm 7 and a first tension roller 8 and also a second tensioning system 9 is arranged with a second tension lever arm 10 and a second tension roller 11. There is also a deflection roller 12.

The first tension roller 8 is arranged in the belt drive directly after the pulley 3 of the air conditioning system compressor AC in the loose run during the starting mode and the second tension roller 11 is arranged directly after the pulley 2 of the crankshaft KW.

FIG. 1 shows the belt drive in the generator mode. Here, the belt 1 is driven by the pulley 2 of the crankshaft KW. The first tension roller 8 is located in pressure contact with a drive-related tensioned run 13, while the second tension roller 11 is located in pressure contact with a drive-related loose run 14.

The belt contact of the first tension roller 8 through the drive-related tensioned run 13 is small. The belt contact of the second tension roller 11 through the drive-related loose run 14 lies at ca. 90°. The angle between the resulting tension force of the two drive-related loose run branches 14a, 14b and the second tension lever arm 10 equals ca. 80°.

FIG. 2 shows the belt drive of FIG. 1 in the starting mode. By changing from the generator mode to the starting mode, the drive-related loose run branches 14a, 14b (FIG. 1) become starter-related tensioned run branches 14a′, 14b′ (FIG. 2). The resulting increased tension force leads to pivoting of the second tension lever arm 10 into a “dead-center position” nearly parallel to the resulting tension force of the tensioned run branches 14a′, 14b′. Therefore, the second tension roller 11 becomes somewhat fixed in position and thus prevents further release of tension in the belt 1. The belt tension necessary for the starting mode is determined just by the correspondingly designed first tensioning system 6. The other labeling of FIG. 2 corresponds to that of FIG. 1.

### REFERENCE SYMBOLS

1 Belt
2 Pulley of crankshaft KW
3 Pulley of an air conditioning system compressor AC
4 Pulley of a starter generator SG
5 Pulley of a water pump WP
6 First tensioning system
7 First tension lever arm
8 First tension roller
9 Second tensioning system
10 Second tension lever arm
11 Second tension roller
12 Deflection roller
13 Drive-related tensioned run (generator mode)
13′ Starter-related loose run (starter mode)
14 Drive-related loose run (generator mode)
14′ Starter-related tensioned run (starter mode)
14a Drive-related loose run branch (generator mode)
14a′ Starter-related tensioned run branch (starter mode)
14b Drive-related loose run branch (generator mode)
14b Starter-related tensioned run branch (starter mode)

1. Traction mechanism drive including a belt drive for secondary units of a combustion engine, comprising a pulley of a crankshaft KW and a pulley of a starter generator SG and also a first tensioning system, which has a first tension lever arm and a first tension roller, as well as with a second tensioning system, which has a second tension lever arm and a second tension roller, wherein the first tension roller is in pressure contact directly after a pulley of an air conditioning system compressor AC with a starter-related loose run over a small belt contact and the second tension roller is in pressure contact directly after the pulley of the crankshaft KW with a drive-related loose run over a belt contact of ca. 90° and the drive-related loose run works in a starting mode as a tensioned run and a change in position of the second tension roller caused by the change to the tensioned run is limited, the second tensioning system is arranged such that the second tension roller for a starter-related tensioned run can be moved out of the belt drive due to the resulting force of two starter-related tensioned run branches only until the second tension lever arm is located in a type of “dead-center position” nearly parallel to a resulting force of the two starter-related tensioned run branches.

2. Traction mechanism drive according to claim 1, wherein the second tensioning system is produced at least partially using an aluminum squeeze casting or rheocasting method or from steel investment casting.

3. Traction mechanism drive according to claim 2, wherein at least one of the two tensioning systems is pre-tensioned and cottered for assembly and that at least a non-cottered one of the tensioning systems has a corresponding tool holder, which is used for tensioning the system out of the belt drive.

4. Traction mechanism drive according to claim 3, wherein the two tensioning systems for the generator and the starting mode have a separate design adapted to a corresponding operating state.
